(19) United States
(12) Patent Application Publication
(10) Pub. No.: US 2024/0202889 A1
(43) Pub. Date: Jun. 20, 2024

(54) METHOD, COMPUTER PROGRAM, AND DEVICE FOR DETERMINING A CALIBRATION MATRIX FOR A CAMERA

(71) Applicant: Elektrobit Automotive GmbH, Erlangen (DE)

(72) Inventors: Seyed Hami Nourbakhsh, Nürnberg (DE); Kavin Chandrasekaran, München (DE)

(73) Assignee: Elektrobit Automotive GmbH, Erlangen (DE)

(21) Appl. No.: 18/543,727

(22) Filed: Dec. 18, 2023

(30) Foreign Application Priority Data
Dec. 19, 2022 (DE) 10 2022 213 952.6

(51) Int. Cl. G06T 5/80; G06T 7/246; G06T 7/70; G06T 7/80; G06V 10/74; G06V 10/764

(52) U.S. Cl. CPC G06T 5/80; G06T 7/246; G06T 7/70; G06T 7/80; G06V 10/761; G06V 10/764; G06V 2201/07

(57) ABSTRACT

A calibration matrix is determined for a camera for an automotive vehicle. In a first step, at least one object is detected, which moves in a sequence of camera images between image areas having different levels of distortion. In particular, feature tracking can be carried out for the at least one object. To determine the calibration matrix, first an expected perspective-related distortion of the at least one object is calculated. Moreover, an observed distortion of the at least one object is determined. A camera-related distortion of the at least one object is calculated from the observed distortion and the expected perspective-related distortion. A calibration matrix can then be calculated from the camera-related distortion. This matrix can be applied to the camera images. The method steps can then be iteratively repeated until a minimal camera-related distortion is achieved.

### CROSS-REFERENCE TO RELATED APPLICATIONS

The present application claims the benefit and/or priority of German Application No. 10 2022 213 952.6 filed on Dec. 19, 2022 the content of which is incorporated by reference herein.

### TECHNICAL FIELD

The present invention relates to a method, a computer program having instructions, and a device for determining a calibration matrix for a camera. The invention moreover relates to a means of transportation which uses such a device or such a method.

### BACKGROUND

Cameras are increasingly being installed in modern means of transportation for detecting the surroundings. The data of these cameras are used, inter alia, by assistance systems of the means of transportation, for example, by lane keeping assistants or systems for traffic sign identification.

The quality of the images supplied by the cameras is becoming more and more important in the course of the progressive development of (semi-)autonomous means of transportation. For this reason, it is often necessary to calibrate the cameras, for example, to be able to compensate for image distortions caused by the camera lenses. Such distortions are particularly pronounced in wide-angle cameras, for example.

Different techniques are used for calibrating cameras to eliminate distortions. Many approaches use images of a chessboard pattern to calculate the intrinsic and extrinsic parameters of the camera.

For example, the article by Z. Zhang: “A Flexible New Technique for Camera Calibration”, Microsoft Research Technical Report MSR-TR-98-71 (1998), describes a technique for calibrating a camera in which the camera only has to observe a planar pattern in two or more different orientations. Either the camera or the planar pattern can be moved freely. The movement does not have to be known. The radial lens distortion is modeled. The method consists of a solution in closed form, followed by a nonlinear refinement on the basis of the criterion of maximum likelihood.

If a wide-angle camera is used, the distortion cannot be completely removed at the image edges if a chessboard pattern is used for the calibration, since such a solely algebraic optimization leads to unstable calibration results in this case. Moreover, localizing features with subpixel accuracy is very difficult to achieve in poor light conditions.

### SUMMARY

It is an object of the present invention to provide improved solutions for determining a calibration matrix for a camera.

This object is achieved by a method, a computer program comprising instructions, a device, and a means of transportation having the features of the independent claims. Preferred embodiments of the invention are the subject matter of the dependent claims.

According to a first aspect of the invention, a method for determining a calibration matrix for a camera comprises the following steps:
detecting at least one object, which moves in a sequence of camera images between image areas with different levels of distortion;
calculating an expected perspective-related distortion of the at least one object;
determining an observed distortion of the at least one object;
calculating a camera-related distortion of the at least one object from the observed distortion and the expected perspective-related distortion; and
calculating a calibration matrix from the camera-related distortion.

According to a further aspect of the invention, a computer program comprises instructions that, when executed by a computer, prompt the computer to carry out the following steps for determining a calibration matrix for a camera:
detecting at least one object, which moves in a sequence of camera images between image areas with different levels of distortion;
calculating an expected perspective-related distortion of the at least one object;
determining an observed distortion of the at least one object;
calculating a camera-related distortion of the at least one object from the observed distortion and the expected perspective-related distortion; and
calculating a calibration matrix from the camera-related distortion.

The term computer is intended to be understood in broad terms. In particular, it also comprises control modules, embedded systems, and other processor-based data processing devices.

The computer program can be provided for electronic retrieval or can be stored on a computer-readable storage medium, for example.

According to a further aspect of the invention, a device for determining a calibration matrix for a camera has:
an object recognition module, which is configured to detect at least one object that moves in a sequence of camera images between image areas with different levels of distortion; and
a computing module, which is configured to calculate an expected perspective-related distortion of the at least one object, to determine an observed distortion of the at least one object, to calculate a camera-related distortion of the at least one object from the observed distortion and the expected perspective-related distortion, and to calculate a calibration matrix from the camera-related distortion.

The solution according to the invention is based on the concept of evaluating, in the camera images, the distortion of objects which move between image areas having different levels of distortion, for example, from an image area in which they are not distorted or less distorted, into an image area in which they are more strongly distorted. In this case, those components are calculated out of the observed distortion which result from a transformation of the objects due to the perspective geometry. The remaining component of the distortion then results from the parameters of the camera. The solution according to the invention has the advantage that the calibration in particular also supplies good results for wide-angle cameras. Moreover, there is the possibility of operating the camera with different lenses without having to carry out a calibration under defined conditions after changing the lens. Instead, the calibration takes place in normal operation.

According to one aspect of the invention, object recognition and object classification are carried out for the detection of the at least one object. For comprehensive determination of the distortion over the entire image area, it is advantageous to recognize and classify as many objects as possible in the images. The classification of the objects simplifies, in the further course of the method, identifying identical objects in successive images and calculating the distortion resulting from the perspective geometry.

According to one aspect of the invention, distance and position of the at least one object are determined in successive camera images. The expected perspective-related distortion is then calculated on the basis of distance and position. The associated expected distortion in the horizontal and vertical directions can be calculated easily from the change of distance and position in successive images. The distance can be produced, for example, by an evaluation of the size of an object after a prior classification of the object. It is sufficient here for the implementation of the solution according to the invention if the relative distance and position of the at least one object are known, for example, in relation to a vanishing point. Even better results may be achieved if the absolute distance and position of the at least one object are known.

According to one aspect of the invention, so-called feature tracking is carried out for the at least one object, i.e., features of the object are extracted and tracked within the sequence. The features extracted during the feature tracking are then used for the calculation of the expected perspective-related distortion and the determination of the observed distortion. The use of features increases the amount of data available for the calibration, since in general each detected object has a number of features which can be tracked. This permits a significantly finer calculation of the camera-related distortion. In addition, the features form geometric figures, the nonlinear distortions of which, depending on the respective distance to the vanishing point, are a measure of the camera-related distortion. These figures can therefore be additionally evaluated. For this purpose, an expected geometry of a figure in a new image can be calculated on the basis of the recognized features. This can then be compared to the actually measured geometry of the figure in the new image, which is derived from the features recognized in the new image. The camera-related distortion can be ascertained from the deviations established in this case.

According to one aspect of the invention, vanishing points in the camera images are determined for the calculation of the expected perspective-related distortion. The vanishing points are advantageous in particular upon the use of extracted features as the basis for the calculation of the camera-related distortion. Since all tracked features have to have a trajectory to the vanishing point, a deviation from this trajectory, in particular in the edge areas of the camera images, is generated by the lens distortion. A Hough transformation can first be applied to a camera image, in order to find straight lines in the image, to determine the vanishing point of the camera image. If necessary, the camera image can be subjected to filtering beforehand, for example, by a conversion into gray scales or the application of fuzziness masking, etc. By means of a RANSAC algorithm (RANSAC: Random Sample Consensus), an intersection point of the lines found is then determined. This corresponds to the vanishing point sought.

According to one aspect of the invention, the calibration matrix is based on a line by line and column by column scaling of the pixel values of the camera images, in which the scaling of the pixel values increases from a central area of the camera images toward edge areas of the camera images. In particular the distortion at wide angles is reduced by this approach, i.e., in particular the distortion at the edges of the images. On the other hand, the visually important features are retained in the images, which tend to be close to the center of the images. In other words, the less important features are scaled using higher values than the other features. The result is scaling of the images nearly without loss of information and with significantly reduced distortion in relation to the prior art. The line by line and column by column scaling moreover contributes to reducing the calculation time, since it is not necessary to carry out a large number of mathematical calculations as is the case in approaches which use a chessboard pattern.

According to one aspect of the invention, the calculated calibration matrix is applied to the camera images. The method steps are then iteratively repeated until a minimal camera-related distortion is achieved. In this way, an optimized calibration matrix is iteratively obtained, which can be stored at the conclusion or output for further use.

A solution according to the invention is preferably used in a means of transportation in order to determine a calibration matrix for a camera of the means of transportation. The means of transportation can be, for example, a motor vehicle, an aircraft, a rail vehicle, or a watercraft. The solution according to the invention is also advantageously usable in robotics.

### BRIEF DESCRIPTION OF THE DRAWING

Further features of the present invention will become apparent from the following description and the appended claims in conjunction with the figures.

FIG. 1 schematically shows a method for determining a calibration matrix for a camera;

FIG. 2 schematically shows a first embodiment of a device for determining a calibration matrix for a camera;

FIG. 3 schematically shows a second embodiment of a device for determining a calibration matrix for a camera;

FIG. 4 schematically shows a means of transportation that uses a solution according to the invention;

FIGS. 5-7 show a sequence of camera images;

FIG. 8 illustrates the principle of column by column scaling; and

FIG. 9 illustrates the principle of line by line scaling.

### DETAILED DESCRIPTION

For a better understanding of the principles of the present invention, embodiments of the invention will be explained in greater detail below with reference to the figures. The same reference signs are used for identical or functionally identical elements in the figures and are not necessarily described again for each figure. It is obvious that the invention is not restricted to the embodiments illustrated and that the features described can also be combined or modified without departing from the scope of protection of the invention as defined in the appended claims.

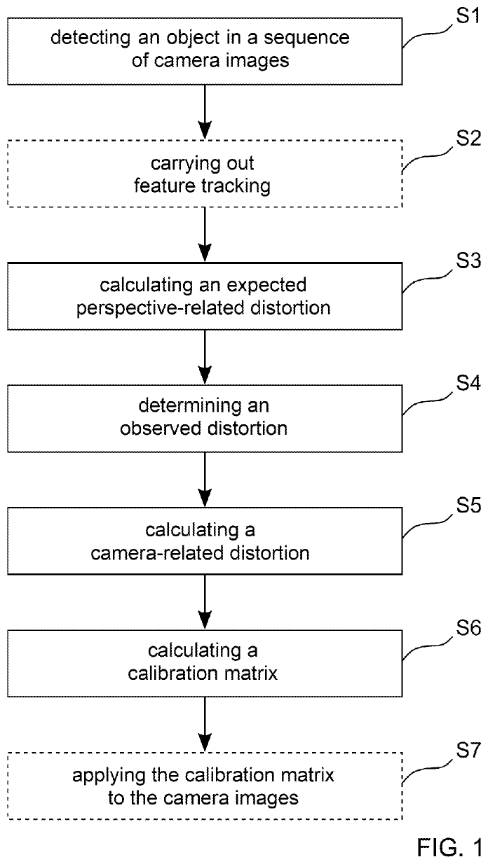

FIG. 1 schematically shows a method for determining a calibration matrix for a camera. In a first step, at least one object is detected S1, which moves in a sequence of camera images between image areas having different levels of distortion. Object recognition and object classification can be carried out for this purpose, for example. In particular feature tracking can be carried out S2 for the at least one object. To determine the calibration matrix, first an expected perspective-related distortion of the at least one object is now calculated S3. Distance and position of the at least one object in successive camera images can be determined as the basis for this step. In addition, vanishing points in the camera images can be determined for this purpose. Moreover, an observed distortion of the at least one object is determined S4. For example, the features extracted during the feature tracking can be used for calculating S3 the expected perspective-related distortion and determining S4 the observed distortion. A camera-related distortion of the at least one object is calculated S5 from the observed distortion and the expected perspective-related distortion. A calibration matrix can now be calculated S6 from the camera-related distortion. This matrix can be applied S7 to the camera images. The method steps can then be iteratively repeated until a minimal camera-related distortion is achieved. The calibration matrix is preferably based on line by line and column by column scaling of the pixel values of the camera images, in which the scaling of the pixel values increases from a central area of the camera images toward edge areas of the camera images.

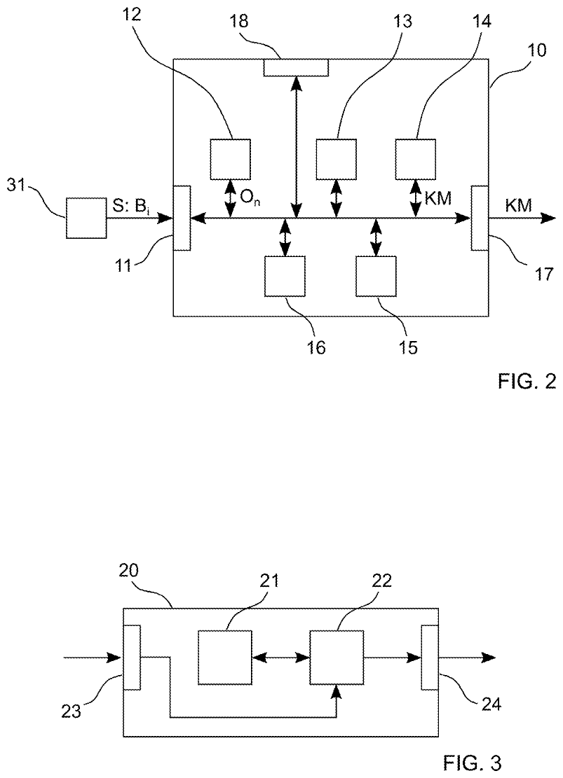

FIG. 2 shows a simplified schematic representation of a first embodiment of a device 10 for determining a calibration matrix for a camera. The device 10 has an input 11, via which a sequence S of camera images Bᵢ of a camera 31 can be received. An object recognition module 12 is configured to detect at least one object Oₙ, which moves in the sequence S of camera images Bᵢ between image areas having different levels of distortion. For this purpose, the object recognition module 12 can carry out, for example, object recognition and object classification. In particular, feature tracking can be carried out by a feature tracker 13 for the at least one object. A computing module 14 is configured to calculate an expected perspective-related distortion of the at least one object Oₙ and to determine an observed distortion of the at least one object Oₙ. The computing module 14 can determine distance and position of the at least one object in successive camera images as the basis for the calculation of the expected perspective-related distortion. In addition, vanishing points in the camera images can be determined for this purpose. The computing module 14 can use, for example, the features extracted by the feature tracker 13 for the calculation of the expected perspective-related distortion and the determination of the observed distortion. The computing module 14 is moreover configured to calculate a camera-related distortion of the at least one object Oₙ from the observed distortion and the expected perspective-related distortion and to calculate a calibration matrix KM from the camera-related distortion. This matrix can be applied to the camera images. The underlying process can then be iteratively repeated until a minimal camera-related distortion is achieved. The resulting calibration matrix KM can be stored or output for further use via an output 17 of the device 10. The calibration matrix KM is preferably based on line by line and column by column scaling of the pixel values of the camera images Bᵢ, in which the scaling of the pixel values increases from a central area of the camera images Bᵢ toward edge areas of the camera images Bᵢ.

The object recognition module 12, the feature tracker 13, and the computing module 14 can be controlled by a control module 15. If necessary, settings of the object recognition module 12, the feature tracker 13, the computing module 14, or the control module 15 can be changed via a user interface 18. The data accumulating in the device 10 can be stored in a memory 16 of the device 10 if necessary, for example, for later evaluation or for use by the components of the device 10. The object recognition module 12, the feature tracker 13, the computing module 14, and the control module 15 can be implemented as dedicated hardware, for example as integrated circuits. Of course, however, they can also be implemented partially or completely in combination or as software that runs on a suitable processor, for example on a GPU or a CPU. The input 11 and the output 17 can be implemented as separate interfaces or as a combined interface.

FIG. 3 shows a simplified schematic representation of a second embodiment of a device 20 for determining a calibration matrix for a camera. The device 20 has a processor 22 and a memory 21. For example, the device 20 is a control device or an embedded system. Instructions are stored in the memory 21 which, when executed by the processor 22, prompt the device 20 to carry out the steps according to one of the described methods. The instructions stored in the memory 21 thus embody a program, which is executable by the processor 22 and which implements the method according to the invention. The device 20 has an input 23 for receiving information. Data generated by the processor 22 are provided via an output 24. Furthermore, the data can be stored in the memory 21. The input 23 and the output 24 can be combined to form a bidirectional interface.

The processor 22 can comprise one or more processor units, for example microprocessors, digital signal processors, or combinations thereof. The memories 16, 21 of the described devices can have both volatile and non-volatile memory areas and can comprise a wide variety of storage devices and storage media, for example hard disks, optical storage media, or semiconductor memories.

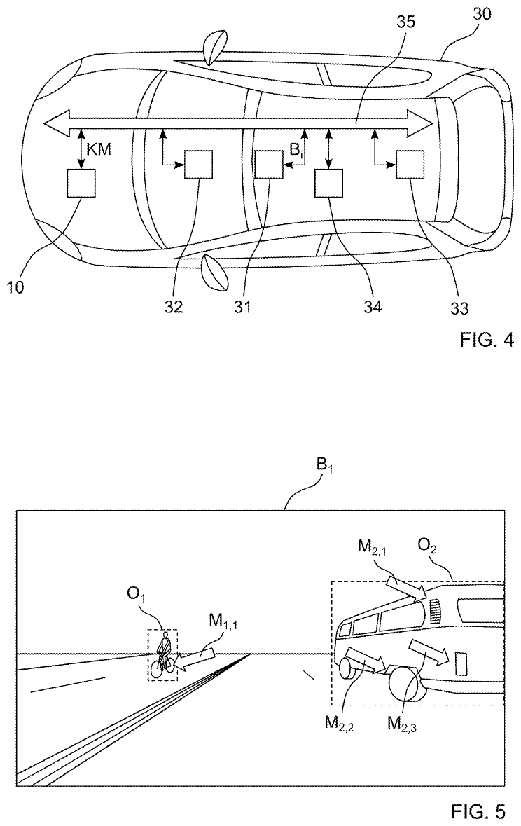

FIG. 4 schematically shows a means of transportation 30 in which a solution according to the invention is implemented. The means of transportation 30 is a motor vehicle in this example. The motor vehicle has a camera 31 for observing the surroundings. The images Bᵢ acquired by the camera 31 can be used by various assistance systems 32, one of which is shown as an example. A device 10 according to the invention is configured to determine a calibration matrix KM for the camera 31, for example, to be able to compensate for the image distortions caused by the camera lenses. In this example, a data transfer unit 33 is a further component of the motor vehicle. For example, a connection to a backend, for example for acquiring updated software for components of the motor vehicle, can be established by means of the data transfer unit 33. A memory 34 is present for storing data. Data are exchanged between the various components of the motor vehicle via a network 35.

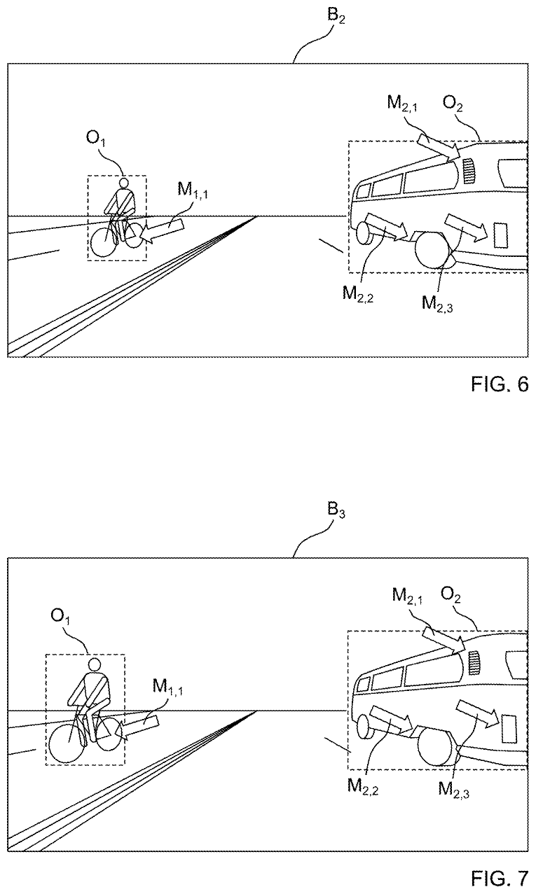

Further details of a solution according to the invention will be described hereinafter on the basis of FIG. 5 to FIG. 9.

FIG. 5 to FIG. 7 show a sequence of camera images Bᵢ. Multiple objects Oₙ are recognizable in the images Bᵢ, which are each marked by a boundary frame. The distortion of the objects Oₙ caused by the perspective geometry, i.e., the deformation and scaling of the objects Oₙ, is calculated in that the distance and position of the moving objects Oₙ is evaluated in multiple successive images Bᵢ. The overall distortion of the objects Oₙ, i.e., the perspective-related distortion plus the camera-related distortion, is calculated from the distortion and displacement of features M_{n,n} of the objects between successive images Bᵢ. Several features M_{n,n} are marked by way of example with arrows in FIG. 5 to FIG. 7.

According to one aspect of the solution according to the invention, not all of the image data are scaled or normalized. Instead, features M_{n,n} are extracted from the images Bᵢ and the pixel values of the feature images are scaled column by column and line by line. If the images Bᵢ are observed more precisely, distortions can be recognized in particular at larger angles. That is to say, the larger the angle is, the more strongly the images Bᵢ are stretched both in the x direction (horizontally) and in the y direction (vertically).

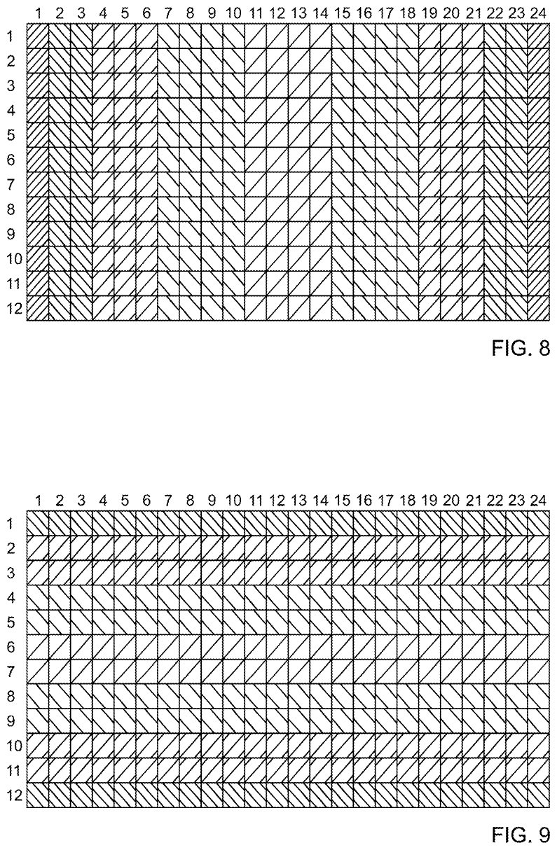

FIG. 8 illustrates the principle of column by column scaling. If an image is represented in the form of a matrix after the feature extraction, an n×m matrix is obtained, as schematically shown in FIG. 8 and FIG. 9. The goal is to scale the pixel values both column by column and line by line, wherein a type of ratio scaling is carried out. The column by column scaling, shown in FIG. 8, will be considered first. Due to the increasing distortion with increasing angle, which is illustrated in FIG. 8 by the density of the hatching of the columns, the column 1 on the outside left and the column 24 on the outside right require a greater scaling value than the columns 11 to 14 in the middle. Column by column scaling therefore means that the value of the scaling factor is dependent on the column considered. In particular, the value of the scaling factor decreases when the column number approaches the middle column. In other words, the image is compressed in the direction of the center from both the left and the right. It can thus be ensured that the image is scaled correctly in the x direction.

FIG. 9 illustrates the principle of line by line scaling. To scale the image in the y direction, an analogous procedure to the x scaling is used, but this time from above and below in the direction of the center. Due to the increasing distortion with increasing angle, which is illustrated in FIG. 9 by the density of the hatching of the lines, the uppermost line 1 and the lowermost line 12 require a greater scaling value than the lines 6 and 7 in the middle. Line by line scaling therefore means that the value of the scaling factor is dependent on the observed line. In particular, the value of the scaling factor decreases when the line number approaches the middle line. In other words, the image is compressed both from above and from below in the direction of the center. It can thus be ensured that the image is scaled correctly in the y direction.

### LIST OF REFERENCE SIGNS

10 device
11 input
12 object recognition module
13 feature tracker
14 computing module
15 control module
16 memory
17 output
18 user interface
20 device
21 memory
22 processor
23 input
24 output
30 means of transportation
31 camera
32 assistance system
33 data transfer unit
34 memory
35 network
Bᵢ camera image
KM calibration matrix
M_{n,n} feature
Oₙ object
S sequence
S1 detecting an object in a sequence of camera images
S2 carrying out feature tracking
S3 calculating an expected perspective-related distortion
S4 determining an observed distortion
S5 calculating a camera-related distortion
S6 calculating a calibration matrix
S7 applying the calibration matrix to the camera images

1. A method for determining a calibration matrix for a camera, comprising the following steps:
detecting at least one object, which moves in a sequence of camera images between image areas having different levels of distortion;
calculating an expected perspective-related distortion of the at least one object;
determining an observed distortion of the at least one object;
calculating a camera-related distortion of the at least one object from the observed distortion and the expected perspective-related distortion; and
calculating a calibration matrix from the camera-related distortion.

2. The method as claimed in claim 1, wherein object recognition and object classification are carried out for the detection of the at least one object.

3. The method as claimed in claim 1, wherein distance and position of the at least one object are determined in successive camera images and the expected perspective-related distortion is calculated on the basis of distance and position.

4. The method as claimed in claim 1, wherein feature tracking is carried out for the at least one object, and the features extracted during the feature tracking are used for calculating the expected perspective-related distortion and determining the observed distortion.

5. The method as claimed in claim 4, wherein vanishing points in the camera images are determined for the calculation of the expected perspective-related distortion.

6. The method as claimed in claim 1, wherein the calibration matrix is based on line by line and column by column scaling of the pixel values of the camera images, in which the scaling of the pixel values increases from a central area of the camera images toward edge areas of the camera images.

7. The method as claimed in claim 1, wherein the calculated calibration matrix is applied to the camera images and the method steps are repeated iteratively until a minimal camera-related distortion is achieved.

8. A non-transitory computer-readable storage medium having stored thereon computer-executable instructions that, when executed by a computer, cause the computer to carry out operations for determining a calibration matrix for a camera, the operations comprising:
detecting at least one object, which moves in a sequence of camera images between image areas having different levels of distortion;
calculating an expected perspective-related distortion of the at least one object;
determining an observed distortion of the at least one object;
calculating a camera-related distortion of the at least one object from the observed distortion and the expected perspective-related distortion; and
calculating a calibration matrix from the camera-related distortion.

9. A device for determining a calibration matrix for a camera, comprising:
an object recognition module, which is configured to detect at least one object that moves in a sequence of camera images between image areas having different levels of distortion; and
a computing module, which is configured to calculate an expected perspective-related distortion of the at least one object, to determine an observed distortion of the at least one object, to calculate a camera-related distortion of the at least one object from the observed distortion and the expected perspective-related distortion, and to calculate a calibration matrix from the camera-related distortion.

10. The device as claimed in claim 9, wherein object recognition and object classification are carried out for the detection of the at least one object.

11. The device as claimed in claim 9, wherein distance and position of the at least one object are determined in successive camera images and the expected perspective-related distortion is calculated on the basis of distance and position.

12. The device as claimed in claim 9, wherein feature tracking is carried out for the at least one object, and the features extracted during the feature tracking are used for calculating the expected perspective-related distortion and determining the observed distortion.

13. The device as claimed in claim 12, wherein vanishing points in the camera images are determined for the calculation of the expected perspective-related distortion.

14. The device as claimed in claim 9, wherein the calibration matrix is based on line by line and column by column scaling of the pixel values of the camera images, in which the scaling of the pixel values increases from a central area of the camera images toward edge areas of the camera images.

15. The device as claimed in claim 9, wherein the calculated calibration matrix is applied to the camera images and the method steps are repeated iteratively until a minimal camera-related distortion is achieved.

16. The non-transitory computer-readable storage medium of claim 8, wherein object recognition and object classification are carried out for the detection of the at least one object.

17. The non-transitory computer-readable storage medium of claim 8, wherein distance and position of the at least one object are determined in successive camera images and the expected perspective-related distortion is calculated on the basis of distance and position.

18. The non-transitory computer-readable storage medium of claim 8, wherein feature tracking is carried out for the at least one object, and the features extracted during the feature tracking are used for calculating the expected perspective-related distortion and determining the observed distortion.

19. The non-transitory computer-readable storage medium of claim 18, wherein vanishing points in the camera images are determined for the calculation of the expected perspective-related distortion.

20. The non-transitory computer-readable storage medium of claim 8, wherein the calibration matrix is based on line by line and column by column scaling of the pixel values of the camera images, in which the scaling of the pixel values increases from a central area of the camera images toward edge areas of the camera images.

21. The non-transitory computer-readable storage medium of claim 8, wherein the calculated calibration matrix is applied to the camera images and the method steps are repeated iteratively until a minimal camera-related distortion is achieved.
